(19) United States
(12) Patent Application Publication
(10) Pub. No.: US 2009/0276673 A1
(43) Pub. Date: Nov. 5, 2009

(54) METHODS AND SYSTEMS FOR OPTIMIZING HARQ COMMUNICATION

(75) Inventors: Mamadou KONE, Jhudong Township (JP); Ming-Hung Tao, Tainan City (TW); Ying-Chuan Hsiao, Jhubei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/342,456

(22) Filed: Dec. 23, 2008

Related U.S. Application Data
(60) Provisional application No. 61/050,358, filed on May 5, 2008.

(51) Int. Cl. H04L 1/18; G06F 11/14

(52) U.S. Cl. 714/749; 714/748; 714/E11.113

(57) ABSTRACT

A method and apparatus for optimizing communication in a communication system is provided. The method includes transmitting a plurality of data packets including a first data packet, storing at least one of the plurality of data packets in a first buffer when the first data packet includes an error, determining a remaining storage capacity of the first buffer based on an initial storage capacity of the first buffer and a storage capacity used to store the at least one of the plurality of data packets, and retransmitting the first data packet with additional data, wherein an amount of the additional data is included in the retransmission based on the remaining storage capacity.

### RELATED APPLICATIONS

This application claims priority from U.S. Provisional Patent Application No. 61/050,358 filed May 5, 2008, the contents of which are hereby incorporated by reference in their entirety.

### BACKGROUND

1. Technical Field

The system and method disclosed herein relates to the field of telecommunication and, more specifically, to a system and method that optimize Hybrid Automatic Repeat ReQuest (HARQ) communication.

2. Description of Related Art

A communication network facilitates the exchange of data between or among various electronic devices, such as a mobile station (MS), a base station (BS), an access point, a cellular phone, a personal digital assistant, a radio, a personal computer, a notebook, a workstation, a global positioning device, a server, and other devices that may be used to transmit and/or receive data. The increased use of electronic devices has resulted in an increased demand for high-speed, reliable, and secure transmission of data, via a communication network.

FIG. 1A illustrates a conventional communication system 100. Specifically, system 100 may include a communication network 102 that facilitates communication between a base station (BS) 104 and a mobile station (MS) 106, where MS 106 includes a soft buffer 108 and a reordering buffer 110 being able to store six data packets at one time. BS 104 transmits data packets to MS 106 over HARQ channels 112. HARQ channels 112 may be identified by HARQ channel Identifier (ACID) within a HARQ connection, which identify a number of bits that can be transmitted per channel (transmission capacity). Several HARQ channels can be used per CID (Connection Identifier) to transmit HARQ data packets. As is illustrated in FIG. 1A three ACIDs may be used per CID to transmit data packets over HARQ channels 112.

During Hybrid Automatic Repeat ReQuest (HARQ) communication, BS 104 may generate data packets and include, prior to transmission, error detection information bits in the data packets. Depending on the transmission capacity of channels 112, data packets are encoded, transmitted, and decoded in a sequence with multiple data packets being transmitted together. MS 106 may receive the data packets over HARQ channels 112 and retrieve error detection information bits from the received data packets to detect whether the transmitted data packets are corrupt or include errors. When MS 106 determines that a data packet of a HARQ channel includes errors that may not be corrected by MS 106, a No Acknowledgment (NAK) message may be sent to BS 104 and retransmission of the corrupted data packet may be requested over the same HARQ channel.

MS 106 may also send an Acknowledgment (ACK) to BS 104 for data packets of a HARQ channel that did not include an error and depending on the sequence of the error-free data packets, MS 106 may retrieve information from data packets that may be processed independent of the corrupt data packet. The remaining data packets may be out of sequence and may be stored in reordering buffer 110 until a substitute for the corrupt data packet is retransmitted, because the remaining data packets may need to be processed with the retransmitted data packet.

To use HARQ channels 112 efficiently communication system 100 retransmits a substitute for the corrupt data packet on its dedicated HARQ channel along with additional data packets on the remaining HARQ channels of channels 112. Thus, for each retransmission of a corrupt data packet, additional data packets, that may be out of order, may be stored in reordering buffer until the retransmitted data packet is received error-free and the data packets in the reordering buffer 110 are processed with the error-free retransmitted data packet or the maximum number of retransmission is reached in which case, upper layer protocols might recover the corrupt data. The out of order data packets that have to be stored, however, may cause reordering buffer 110 overflows or may increase its memory requirement, causing the communication between BS 104 and MS 106 to stall. Further, upon detecting overflow of reordering buffer 110, MS 106 may remove unprocessed data packets from reordering buffer 110 to accommodate additional data packets, which may cause further stalling, processing delays, transmission errors, and/or data loss.

FIG. 1B illustrates a conventional communication sequence of communication system 100. As illustrated in FIG. 1B, at time T₁ BS 104 may transmit data packets P1, P2, and P3 through HARQ channels ACID1, ACID2 and ACID3, with the maximum number of retransmission limited to three(3). At time T₂, MS 106 may receive data packets P1, P2, and P3, and may detect that data packet P2 includes errors and may send back a NAK message for data packet P2 and ACK messages for data packets P1 and P3. Data packet P1 is the first data packet in the sequence and may therefore be processed without an error-free data packet P2, but data packet P3 may only be processed with an error-free data packet P2, because of possible fragmentation of the same packet data unit in P2 and P3 and is therefore stored in reordering buffer 110. Corrupt data packet P2 may be stored in soft buffer 108 as it may be combined with a subsequent retransmission of data packet P2. A soft buffer may be allocated per HARQ channel and may store a corrupt data packet in order to combine the corrupt data packet with retransmitted data packets, so that data in the corrupt data packet may be recovered. Soft buffer 108 may represent an aggregation of a plurality of soft buffers corresponding to HARQ channels 112, and the capacity of soft buffer 108 may be based on the capacities of all the soft buffers.

At time T₃, BS 104 retransmits data packet P2 on HARQ channel ACID2 with additional data packets P4 and P5 on remaining channels ACID1 and ACID3. These data packets may be received by MS 106, however, an error-free data packet P2 may still not be received and at time T₄, and data packets P4 and P5 may be stored in reordering buffer 110 for the same reason as above, while retransmitted data packet P2 is stored in soft buffer 108. Similarly, at time T₅ another attempt may be made to receive an error-free data packet P2, while additional data packets P6 and P7 may also be transmitted on the remaining HARQ channels. However, the attempt may fail and at time T₆, data packets P6 and P7 may be stored in reordering buffer 110 along with data packets P3, P4, and P5, all of which may be processed with an error-free data packet P2. This may cause reordering buffer 110 to use up most or all of its storage capacity or to require more memory capacity.

As additional data packets P8 and P9 are transmitted at time T₇, due to a maximum number of retransmission of three, reordering buffer 110 may overflow and may drop at least one data packet from reordering buffer 110 to accommodate data packets P8 and P9. For example, data packet P3 may be dropped without being processed causing communication stalling, processing delays, transmission errors, and/or data loss. To avoid this drop, the memory requirement of the reordering buffer has to be big enough to accommodate with the number of HARQ channels and the maximum number of retransmission. However, increasing the memory capacity may require additional resources and may result in cost increases. Therefore, it would be desirable to provide methods and apparatus to overcome one or more of the shortcomings noted above.

### SUMMARY

Consistent with embodiments of the present invention, a method for optimizing communication in a communication system is provided. The method comprises transmitting a plurality of data packets including a first data packet; storing at least one of the plurality of data packets in a first buffer when the first data packet includes an error; determining a remaining storage capacity of the first buffer based on an initial storage capacity of the first buffer and a storage capacity used to store the at least one of the plurality of data packets; and retransmitting the first data packet with additional data, wherein an amount of the additional data is included in the retransmission based on the remaining storage capacity.

Also, consistent with embodiments of the invention, there is provided a method for optimizing communication in a communication system that includes receiving a plurality of data packets including a first data packet; storing at least one of the plurality of data packets in a first buffer when the first data packet includes an error; requesting retransmission of the first data packet; and receiving retransmission of the first data packet with additional data, wherein an amount of the additional data is included in the retransmission based on a remaining storage capacity of the first buffer that is determined based on an initial storage capacity of the buffer and a storage capacity used to store the at least one of the plurality of data packets.

Further consistent with embodiments of the present invention, an apparatus for optimizing communication is provided. The apparatus comprises a first buffer having an initial storage capacity; a receiver to receive a plurality of data packets including a first data packet, wherein at least one of the plurality of data packets is stored in the first buffer when the first data packet includes an error; a processor to determine a remaining storage capacity of the first buffer based on the initial storage capacity and a storage capacity used to store the at least one of the plurality of data packets; and a transmitter to request retransmission of the first data packet, wherein the receiver receives retransmission of the first data packet with additional data, an amount of the additional data included in the retransmission based on the remaining storage capacity of the first buffer.

Also consistent with embodiments of the present invention, there is provided an apparatus for optimizing communication, the apparatus comprising a transmitter to transmit a plurality of data packets including a first data packet, wherein at least one of the plurality of data packets is stored in a first buffer when the first data packet includes an error; and a receiver to receive a request of retransmission of the first data packet, wherein the transmitter retransmits the first data packet with additional data, an amount of the additional data included in the retransmission based on a remaining storage capacity of the first buffer determined based on an initial storage capacity of the first buffer and a storage capacity used to store the at least one of the plurality of data packets.

Additionally consistent with embodiments of the present invention, a communication system optimizing communication between a first node and a second node is provided. The system comprises a first buffer having an initial storage capacity, the first buffer being included in the second node; a first node transmitter to transmit a plurality of data packets, including a first data packet, to the second node, wherein at least one of the plurality of data packets is stored in the first buffer when the first data packet includes an error; and a second node transmitter requesting retransmission of the first data packet such that the first node transmitter retransmits the first data packet with additional data to the second node, wherein an amount of the additional data is included in the retransmission based on a remaining storage capacity of the first buffer that is determined based on the initial storage capacity and a storage capacity used to store the at least one of the plurality of data packets.

It is to be understood that both the foregoing general description and the following detailed description are exemplary and explanatory only, and are not restrictive of the invention, as claimed.

### BRIEF DESCRIPTION OF THE DRAWINGS

The accompanying drawings, which are incorporated in and constitute a part of this specification, illustrate various embodiments. In the drawings:

FIG. 1A is a schematic diagram of a conventional communication system;

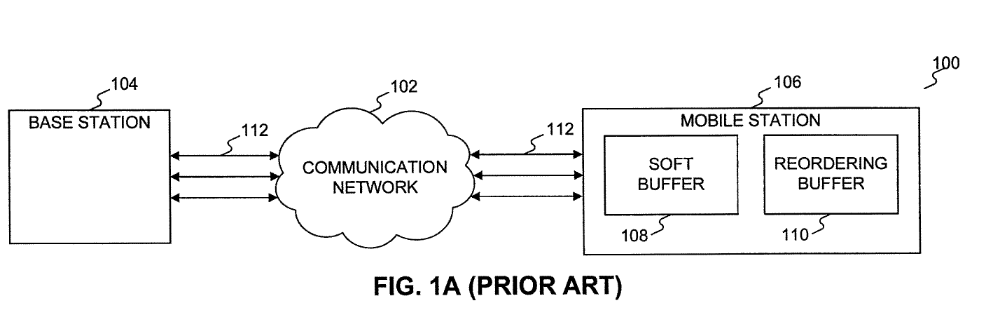

FIG. 1B is a schematic diagram of a conventional communication sequence;

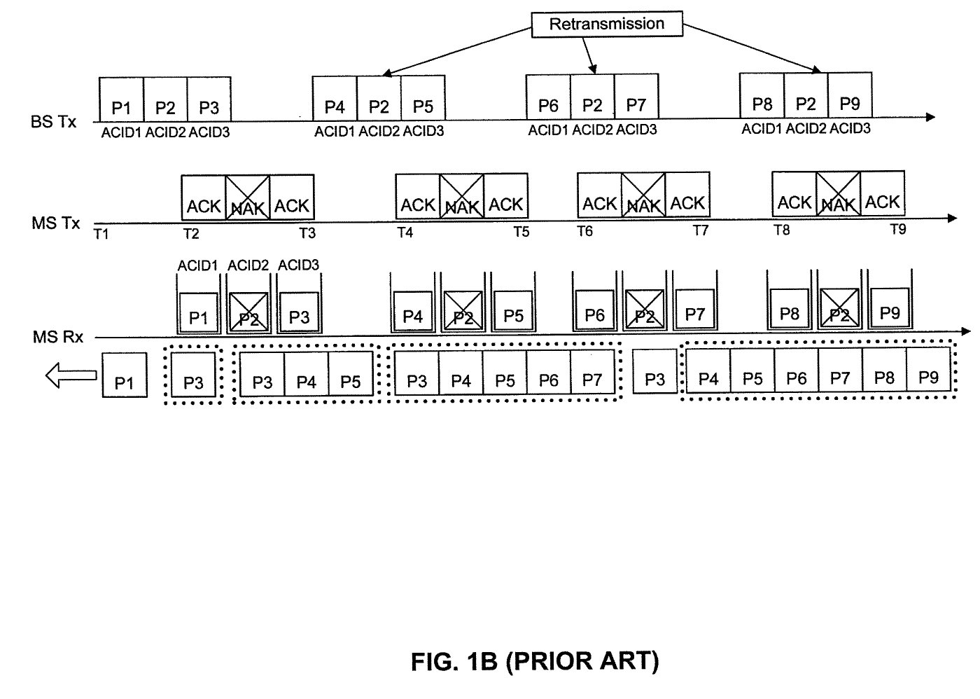

FIG. 2 is a schematic diagram illustrating an exemplary communication system, in accordance with the invention;

FIG. 3 is a schematic diagram of a communication sequence, in accordance with the invention; and

FIG. 4 illustrates a flow diagram of an exemplary method for optimizing HARQ communication, in accordance with the invention.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented herein. While the techniques and embodiments will primarily be described in context with the accompanying drawings, those skilled in the art will further appreciate that the techniques and embodiments can also be practiced in other communication systems.

Reference will now be made in detail to exemplary embodiments of the invention, examples of which are illustrated in the accompanying drawings. Wherever possible, the same reference numbers will be used throughout the drawings to refer to the same or like parts.

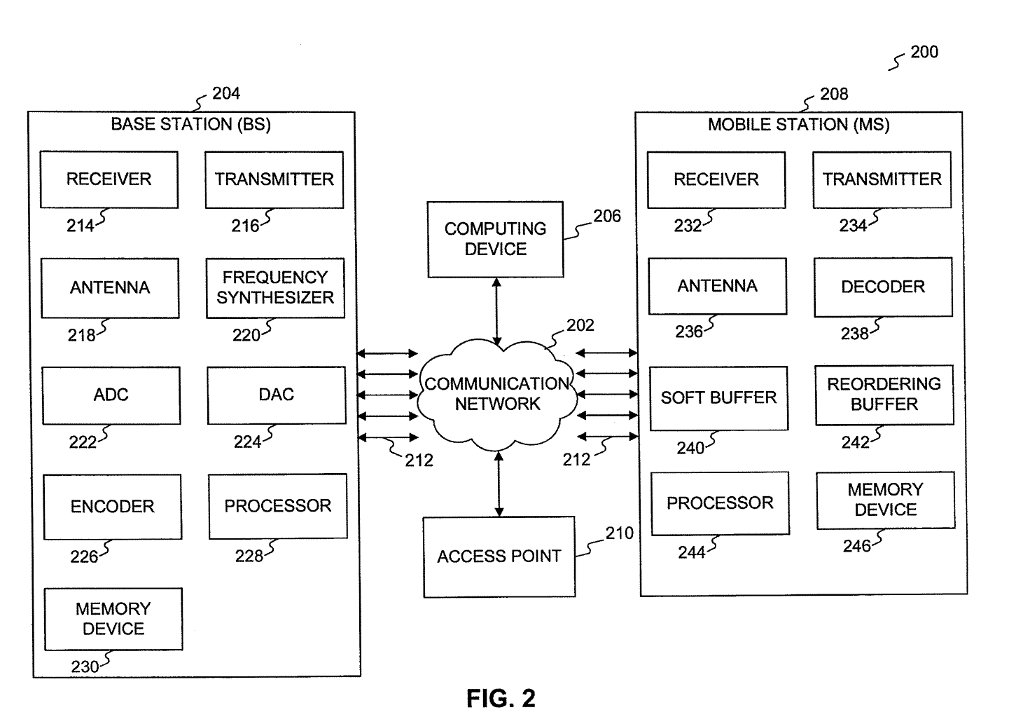

FIG. 2 illustrates a communication system 200 for optimizing Hybrid Automatic Repeat ReQuest (HARQ) communication between or among electronic devices. Communication system 200 facilitates communication between or among various electronic devices by way of processing, transmitting, and/or receiving data packets. Specifically, system 200 may include a communication network 202 that facilitates communication between or among two or more of a plurality of nodes 204, 206, 208, and/or 210. Communication network 202 may include one or more network types, such as a wide-area network (WAN), a local-area network (LAN), a 3G network, a Worldwide Interoperability for Microwave Access (WiMAX) network, a Long Term Evolution (LTE) network, Code-Division Multiple Access (CDMA) network, Wideband CDMA (WCDMA) network, or any other appropriate protocol to facilitate communication between two or more of nodes 204, 206, 208, and/or 210. Communication network 202 may operate by wireline and/or wireless techniques and may, but need not, operate in accordance with protocols defined in IEEE 802.11, 802.11a, 802.11b, 802.11e, 802.11g, 802.11h, 802.11i, 802.11n, 802.16, 802.16d, 802.16e, and/or 802.16m. Network connections between or among the nodes of communication system 200 may be established via Ethernet, telephone line, cellular channels, or other transmission media.

One or more nodes of communication system 200 can include a combination of one or more application program and/or one or more hardware component. For example, an application program may include a software module, a sequence of instructions, a routines, a data structure, a display interfaces, and/or another type of structure that executes operation of the present invention. Further, a hardware component may include a combination of Central Processing Units (CPUs), buses, memory devices, storage units, data processors, control devices, transmitters, receivers, antennas, transceivers, input devices, output devices, network interface devices, and/or another type of component that is apparent to those skilled in the art.

As shown in FIG. 2, nodes 204, 206, 208, and 210 of communication system 200 may respectively represent a base station (BS) 204, a computing device 206, a mobile station (MS) 208, and an access point 210. Nodes 202, 204, 206, 208, and 210 may use communication network 202 to send and/or receive data packets over HARQ channels 212. HARQ channels 212 may be identified by HARQ channel identifiers (ACIDs) within a HARQ connection, which identify a number of bits that can be transmitted per HARQ channel (transmission capacities). Several HARQ channels can be used per CID (Connection Identifier) to transmit HARQ data packets. These CIDs may be used by nodes 204, 206, 208, and 210, to determine a number of data packets that may be transmitted over HARQ channels 212. Nodes 204, 206, 208, and 210 may perform various processing operations using the data packets. For example, a data packet may be processed by mobile station 208 to acquire system configurations of base station 204 or to read out resource allocation of downlink (DL) and uplink (UL) transmissions. It is to be understood that HARQ channels 212 may be included in system for exemplary purposes and may be replaced by any other communication channels that will be apparent to those of skill in the art.

As is illustrated in FIG. 2, BS 204 may include one or more of a receiver 214 for receiving one or more data packets, a transmitter 216 for transmitting one or more data packets, and antenna(s) 218 for directing transmission and/or reception of data packets. BS 204 may also include a frequency synthesizer 220 for controlling the frequency of signals transmitted by transmitter 216, an analog to digital converter (ADC) 222 for down-converting signals, a digital to analog converter (DAC) 224 for up-converting signals, an encoder 226 for encoding data with error detection (ED) bits to generate data packets for transmission, a processor 228 for directing various processing tasks in BS 204, and a memory device 230 for storing data that may be retrieved and used as BS 204 performs various processing tasks. For example, memory device 230 may include data and/or error detection code to be encoded by encoder 226 to generate data packets for transmission. Memory device 230 may also store predetermined values such as addresses of nodes 206, 208, and 210, CIDs and transmission/reception capacity of HARQ channels 212, and information regarding characteristics of communication network 202 and nodes 206, 208, 210, which may be used to facilitate communication between the nodes.

MS 208 may include one or more of a receiver 232 for receiving one or more data packets, a transmitter 234 for transmitting one or more data packets and/or notification messages, and antenna(s) 236 for directing transmission and/or reception of data packets. MS 208 may also include a decoder 238 for decoding received data packets and detecting errors in the received data packets, a soft buffer 240 assigned per HARQ channel or as an aggregation of the soft buffer of all HARQ channels for storing received data packets that may include errors and/or may be corrupt, for combining purpose with a retransmitted data packet, a reordering buffer 242 assigned per connection or per priority order for storing received out of order or non-sequential data packets that may be processed with a data packet that may be retransmitted after detection of a corrupt data packet, a processor 244 for directing various processing tasks in MS 208, and/or a memory device 246 for storing information retrieved from the received data packets and/or data that may be retrieved and used as MS 208 performs various processing tasks. For example, memory device 246 may store predetermined values that may be used to facilitate communication between nodes 204, 206, 208, and 210.

Processors 228 and 244 may be medium access controllers (MACs) and/or physical layer processing circuits, and/or memory devices 230 and 246 may include any or all forms of non-volatile or volatile memory, including, by way of example, semiconductor memory devices, such as EPROM, RAM, ROM, DRAM, EEPROM, and flash memory devices; magnetic disks such as internal hard disks and removable disks; magneto-optical disks; and CD-ROM disks. Memory devices 230 and 246 may include computer-readable storage medium including application programs, code, and/or instructions that may be executed on processors 228 and 244, respectively, during performance of various processing tasks performed by BS 204 and MS 208.

BS 204 and MS 208 may also include additional components, and/or computing device 206, and access point 210 may but need not include components similar to the ones included in BS 204 and/or MS 208.

Consistent with an embodiment of the invention, BS 204 may acquire the initial storage capacity of reordering buffer 242. For example, BS 204 may communicate with MS 208 during the network entry and the system basic capacity negotiation and may acquire the amount of data bits that can be stored in reordering buffer 242 and/or BS 204 may retrieve information stored in memory device 230 that may identify the initial storage capacity of reordering buffer 242. BS 204 may also generate data packets to be transmitted to MS 208 over HARQ channels 212. The data packets may be generated by using encoder 226 to encode data received by receiver 214 and/or by encoding data retrieved from memory device 230. Encoder 226 may also include error detection and/or correction bits in the data packets during generation of the data packets and may generate data packets of appropriate sizes. Alternatively, the data packets may be generated as having arbitrary sizes.

Once the data packets are generated and ready to be transmitted, BS 204 may determine, using CIDs, the transmission capacities of HARQ channels 212 and may use transmitter 216 to distribute the data packets over HARQ channels 212. As described in further detail below, transmissions of data packets may include a certain number of data packets according to the number of HARQ channels, being transmitted in a specific sequence at a specific time. The specific sequence may also identify an order in which the data packet may be processed after transmission.

The transmitted data packets may be received by receiver 232 of MS 208 and may then be provided to decoder 238. Decoder 238 may decode the error detection and/or correction bits included in the generated data packets to detect any errors present in the transmitted data packets. These errors may be caused due to poor channel quality, network defect, and/or BS 204 or MS 208 defects. When all the data packets are detected to be error free MS 208 may send an acknowledgment back to BS 204 indicating that the transmission was successful and may use decoder 238 and/or processor 244 to retrieve data included in the data packets.

Alternatively, when one or more of the data packets may include an error (corrupt data packet) that may not be corrected by MS 208, transmitter 234 is used to send a No Acknowledgment (NAK) for the corrupt data packet(s) and an Acknowledgment (ACK) message for the error-free data packet(s) to BS 204. Among the error-free data packets, the data packets that may be processed without the corrupt data packet are processed by MS 208 and the corrupt data packet may be stored in soft buffer 240 for future processing. The remaining non-sequential data packets may be stored in reordering buffer 242 for future processing with a retransmitted data packet corresponding to the corrupt data packet.

BS 204 may prepare additional data packets for transmission, when receiver 214 receives a NAK message. BS 204 may also determine the remaining storage capacity of reordering buffer 242 and may use this information during generation of additional data packets to be sent on the HARQ channels. The remaining storage capacity may be determined based on the number of remaining out of order or non-sequential data packets that may have been stored in reordering buffer 242 and/or by sending a query to MS 208 to receive a response identifying the remaining storage capacity. BS 204 may also keep track of the number of data packets sent and the number of NAK message received, and use this information combined with the initial storage capacity of the reordering buffer 242 to determine the remaining storage capacity of reordering buffer 242.

For every NAK message that may be received by receiver 214, BS 204 may retransmit the data packet that may have been corrupted during transmission. To use the HARQ channels 212 efficiently, BS 204 may also transmit additional data with the retransmitted data packet. In order to prevent overflow of reordering buffer 242, the amount and type of additional data to be transmitted may be determined based on the remaining storage capacity of reordering buffer 242. For example, if the remaining storage capacity indicates that reordering buffer 242 may only store three additional data packets, BS 204 may retransmit a substitute for the corrupted data packet and two additional data packets.

BS 204 may detect stalling due to repeated corruption of the retransmitted data packet(s) and may include, during retransmission, additional copies of the same data packet(s) that became corrupted instead of adding new additional data packets. Also, instead of additional data packets or additional copies, BS 204 may include additional robust coding, error detection, and/or correction bits with the retransmission of the data packet(s) that may have been previously corrupted. This may increase the probability of retransmitting an error-free data packet and/or enable MS 208 to correct the errors of the corrupt data packet(s) stored in soft buffer 240.

The retransmitted data packet(s) and additional data may be received by receiver 232 and may be evaluated for additional errors by decoder 238. When the retransmitted data packet(s) is received, it may be combined with the corrupt data packet previously stored in soft buffer 240. As will be apparent to those of ordinary skill in the art, chase combining may be performed to combine the retransmitted data packet and the corrupt data packet to retrieve an error-free data packet from these data packets, and the remaining data packets previously stored in reordering buffer 242 may be processed by decoder 238 and/or processor 244 with the combined data packets.

Alternatively, chase combining may not be performed and the retransmitted data packet with robust coding scheme, if error-free, may be processed with the remaining data packets stored in reordering buffer 242. These data packets may be processed by decoder 238 and/or processor 244 for the retrieval of data included in the data packets, and the retrieved data may be stored in memory device 246 and/or used by MS 208 to perform additional processes in communication system 200.

MS 208 may send a NAK and request a second retransmission, when it may be determined that the retransmitted data packet also contains errors. The data packets and/or additional data that may be received by receiver 232 may be processed by MS 208, in a manner similar to the one noted above and the second retransmission may also be performed by BS 204 in a similar manner.

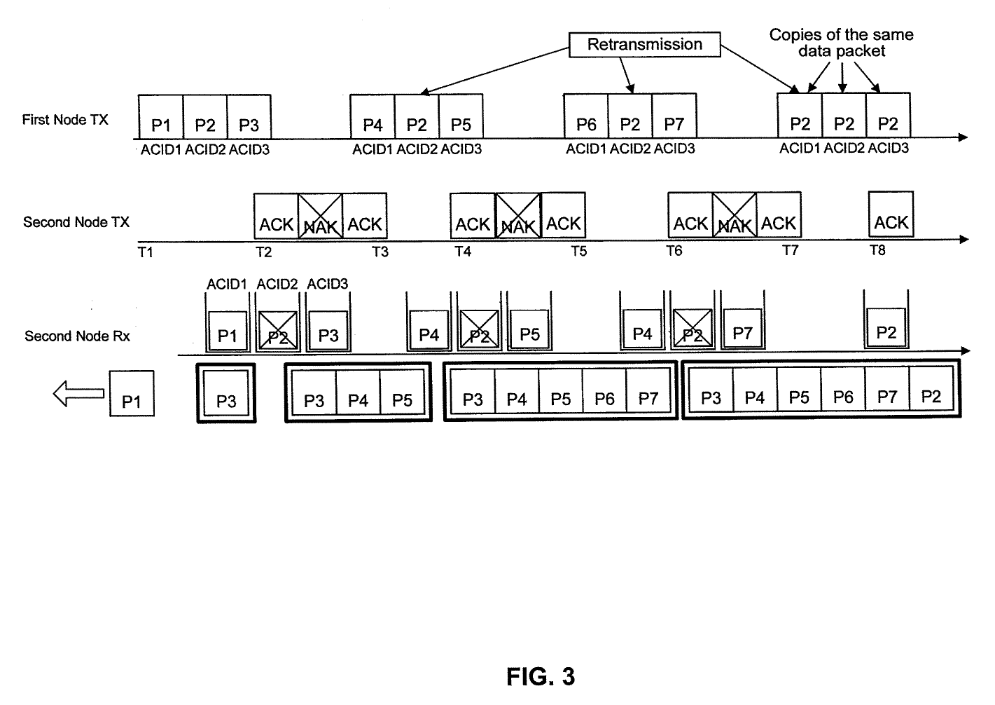

FIG. 3 illustrates a communication sequence 300, in accordance with the invention. Communication sequence 300 may correspond to communication performed in communication system 200. For example, communication sequence 300 may correspond to the flow of information between BS 204 and MS 208 and/or between nodes 204 and 206 of communication system over a connection. As illustrated in FIG. 3, at time T₁ a first node of a communication system may transmit data packets P1, P2, and P3 over a connection. These data packets may be received by MS 208. The quantity and type of data included in data packets P1, P2, and P3, and the number of data packets to be transmitted together, may be determined by the first node based on the negotiated system basic capacity which determines the first buffer size per CID (or per priority order), the channels number and the second buffer size per channel included in a second node. The channels may be HARQ channels, the first buffer may be a reordering buffer, the second buffer may be a soft buffer, and the reordering buffer may only be able to store a maximum of six data packets at one time.

At time T₂, the second node may detect that data packet P2 includes errors and may send back a NAK message for data packet P2 and ACK messages for data packets P1 and P3. Data packet P1 is the first data packet in the sequence and therefore may be processed without an error-free data packet P2 but data packet P3 may only be processed with an error-free data packet P2 and is therefore stored in a reordering buffer of the second node. Corrupt data packet P2 may be stored in a soft buffer corresponding to a channel ACID2 of the second node for future processing.

At time T₃, the first node retransmits data packet P2 with additional data packets P4 and P5, where the number of data packets to be included with the retransmission of data packet P2 may be determined based on a remaining storage capacity (five data packets) of the reordering buffer. The retransmitted data packet P2 may again include errors, and at time T₄, the second node may send back a NAK message along with ACK messages for data packets P2, P4, and P5, respectively. Data packets P4 and P5 may be stored in the reordering buffer included in the first node along with data packet P3 and the retransmitted data packet may be stored in the soft buffer overwriting the previously stored corrupt data packet from the same HARQ channel.

At time T₅ another attempt may be made to receive an error-free data packet P2, while additional data packets P6 and P7 may also be transmitted. The quantity of data bits included in the retransmission may again be determined based on the remaining storage capacity of the reordering buffer (three data packets). However, the attempt may fail and at time T₆, data packets P6 and P7 may be stored in the reordering buffer along with data packets P3, P4, and P5, all of which may be processed with an error-free data packet P2, while the soft buffer may now contain the corrupt data packet P2 from the last packet combined with the previous content of the soft buffer. Also, a NAK message along with two ACK messages corresponding to data packets P2, P6, and P7, may be sent by the second node to the first node.

At time T₇ the first node may determine the remaining capacity of the reordering buffer and may determine that the reordering buffer may only store one more data packet. Therefore, instead of sending multiple new data packets to occupy the number of HARQ channels, the first node may not include new data packets for transmission along with the retransmission of data packet P2. Additionally, the first node may include additional copies of data packet P2 on the remaining two HARQ channels, thus increasing the chance of transmitting an error-free data packet P2.

Upon receiving the copies of data packet P2, the second node may combine the copies of P2 with the corrupted data packet P2, stored in the soft buffer, and may then process the combined data packets to ensure retrieval of an error-free data packet P2 from the copies sent. Subsequently, the error-free data packet P2, may be processed with data packets P3, P4, P5, P6, and P7 in the reordering buffer, and the data packets may be removed from the reordering buffer without causing overflow in the reordering buffer and/or without stalling communication.

Alternatively, instead of transmitting copies of data packet P2, the first node may use the transmission capacity to include a more robust error detection and/or correction bits to ensure that the P2 being retransmitted may be less prone to error, therefore providing the second node with a higher chance of receiving an error free-data packet P2, so that the error-free data packet P2 may be processed along with data packets P3, P4, P5, P6, and P7, and the data packets may be removed from the reordering buffer prior to overflow of the reordering buffer. Thus, processing of all data packets may be ensured without causing the reordering buffer to overflow and/or without causing stalling communication.

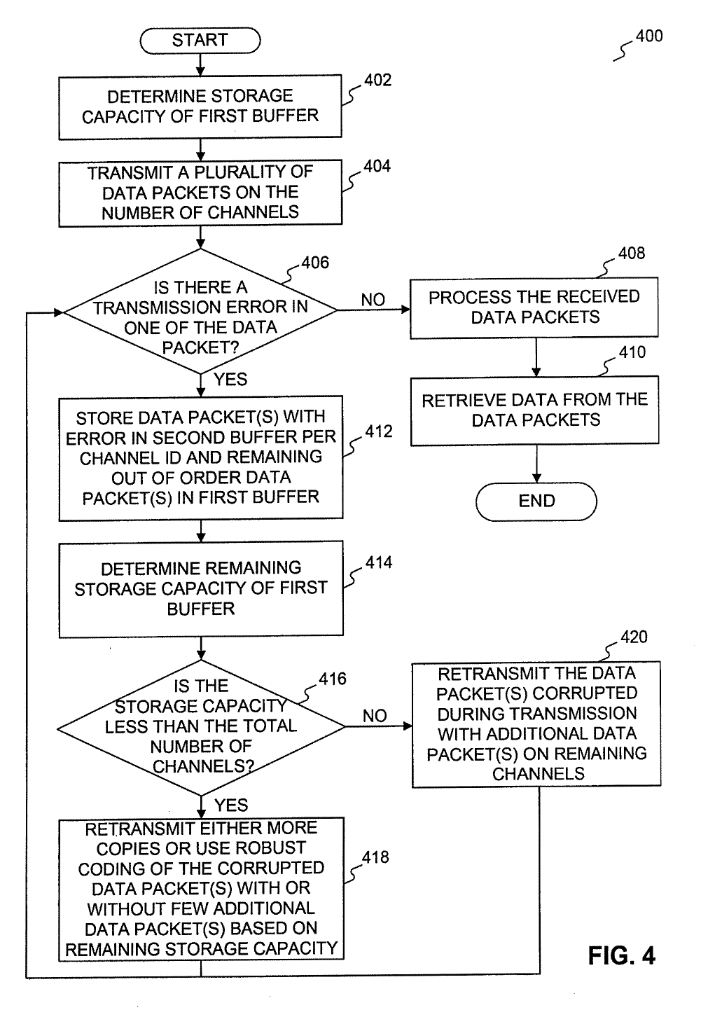

FIG. 4 is a flow chart of an exemplary method 400 for optimizing communication. Method 400 may be implemented using communication system 200 or another system known to those of ordinary skill in the art. Steps 402-420 of method 400 are provided for illustration and not for limitation purposes and may be performed in any sequence. The process begins in step 402 where storage capacity of a first buffer may be acquired by a first node in a communication system. The first buffer may be a reordering buffer and step 402 may be performed by, for example, BS 204 of communication system 200, where storage capacity of reordering buffer 242 may be determined.

Next, in step 404, a plurality of data packets may be transmitted by the first node to a second node over channels in a communication system. For example, the plurality of data packets may be transmitted from BS 204 to MS 208 over HARQ channels 212 of communication system 200. Next, the transmitted data packets may be checked for errors (step 406). If the received data packets are error-free and/or include errors that may be corrected by the second node, the received data packets may be processed (step 408). Also, in step 408 an ACK message may be sent to the first node indicating that the transmitted data packets were received error-free. Step 408 may be performed by, for example, processor 244 in conjunction with receiver 232 of communication system 200. Next, in step 410, data may be retrieved from the processed data packets at the upper layer of the protocol and the method ends.

Returning now to step 406, when an error is detected to be included in one of the data packets the method may move to step 412. In step 412, the corrupt data packet with the error may be stored in a second buffer assigned to the HARQ channel in the second node and some of the remaining data packets may be processed while the data packets that may be processed with an error-free version of the corrupt data packet may be stored in the reordering buffer when out of sequence with the corrupt data packet. Also, in step 412, the second node may send a NAK message (corresponding to the corrupt data packet) and ACK messages (corresponding to the data packet(s) that may be received error-free) to the first node requesting retransmission of the data packet that got corrupted during transmission. The second buffer used in step 412 may be, for example, soft buffer 240 of communication system 200, and the NAK messages may be sent by, for example, transmitter 234.

Next, in step 414, the remaining storage capacity of the reordering buffer is determined and in step 416, the reordering buffer capacity may be compared to the number of HARQ channels capacity, to decide whether to send additional data packets corresponding to the exact number of HARQ channels or not. Next, the method may move to step 418 when the reordering buffer capacity may be available to handle and/or receive additional data packets over all the HARQ channels. In step 418, additional data packets may be transmitted on the remaining HARQ channels along with the corrupt data packet and the method may move back to step 406.

Alternatively, when reordering buffer may not have the capacity to handle and/or receive the transmission of data packets over all the HARQ channels, the method may move to step 420. In step 420, the first node retransmits the data packet that was corrupted during the previous transmission along with or without additional data. The type and quantity of the additional data may be dependent on the remaining storage capacity determined in step 414, where additional data may include copies of the at least one data packet being retransmitted, or robust coding of the at least one data packet being retransmitted, and/or additional data packets. Next, the method may return to step 406, where, depending on the result of step 406, steps 406-420 or steps 406-410 may be repeated.

Although method 400 is described to begin by generating new data packets, one of ordinary skill in the art will appreciate that method 400 may include performing the steps by using data stored in a memory device, or method 400 may occur in response to a data request received by a communication node in a communication system.

The foregoing description has been presented for purposes of illustration. It is not exhaustive and does not limit the invention to the precise forms or embodiments disclosed. Modifications and adaptations of the invention will be apparent to those of ordinary skill in the art from consideration of the specification and practice of the disclosed embodiments of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for optimizing communication in a communication system, comprising:
transmitting a plurality of data packets including a first data packet;
storing at least one of the plurality of data packets in a first buffer when the first data packet includes an error;
determining a remaining storage capacity of the first buffer based on an initial storage capacity of the first buffer and a storage capacity used to store the at least one of the plurality of data packets; and
retransmitting the first data packet with additional data, wherein an amount of the additional data is included in the retransmission based on the remaining storage capacity.

2. The method of claim 1, wherein the at least one data packet having the error is stored in a second buffer such that the first buffer is a reordering buffer and the second buffer is a soft buffer.

3. The method of claim 2, further comprising:
combining the at least one data packet stored in the second buffer and the retransmitted first data packet;
processing the combined data packet; and
processing the at least one data packet stored in the first buffer with the combined data packets, wherein the at least one data packet in the first buffer is processed after the combined data packets are processed.

4. The method of claim 1, further comprising receiving a no acknowledgement message before retransmitting the first data packet, the message indicating that the transmitted first data packet includes an error, and the retransmitting being performed in response to the no acknowledgment message.

5. The method of claim 1, further comprising determining an initial storage capacity of the first buffer, wherein transmission of the plurality of data packets is based on the initial storage capacity.

6. The method of claim 1, wherein the plurality of data packets are transmitted over N HARQ channels such that the initial storage capacity of the first buffer is used to determine a number of the HARQ channels that are used per connection for the transmission.

7. The method of claim 1, wherein the additional data includes a plurality of copies of the first data packet being retransmitted, robust coding of the first data packet being retransmitted, or additional data packets, a type of the additional data being based on the remaining storage capacity and a transmission condition of a channel in the communication system.

8. The method of claim 1, wherein the plurality of data packets are transmitted over HARQ channels identified by HARQ channel identifiers, and a connection identifier using a plurality of HARQ channels to transmit the data packets, the connection identifiers identifying transmission capacities of the HARQ channels, the transmission and the retransmission being controlled based on the transmission capacities and the remaining storage capacity of the first buffer.

9. The method of claim 1, further comprising detecting the error in the first data packet by decoding error detection bits included in the first data packet.

10. The method of claim 1, wherein the plurality of data packets are transmitted in a sequence indicating an order for processing the plurality of data packets, the first data packet being any data packet in the sequence.

11. A method for optimizing communication in a communication system, comprising:
receiving a plurality of data packets including a first data packet;
storing at least one of the plurality of data packets in a first buffer when the first data packet includes an error;
requesting retransmission of the first data packet; and
receiving retransmission of the first data packet with additional data, wherein an amount of the additional data is included in the retransmission based on a remaining storage capacity of the first buffer that is determined based on an initial storage capacity of the buffer and a storage capacity used to store the at least one of the plurality of data packets.

12. The method of claim 11, wherein the received first data packet is stored in a second buffer, the second buffer being allocated per HARQ channel of the communication system such that the first buffer is a reordering buffer and the second buffer is a soft buffer.

13. The method of claim 12, further comprising:
combining the first data packet stored in the second buffer and the retransmitted first data packet;
processing the combined data packets; and
processing the at least one data packet stored in the first buffer with the combined data packets, wherein the at least one data packet first buffer is processed after the combined data packets are processed.

14. The method of claim 11, further comprising transmitting a no acknowledgement message for requesting retransmission of the first data packet, the message indicating that the received first data packet includes an error.

15. The method of claim 11, further comprising determining an initial storage capacity of the first buffer, wherein transmission of the plurality of data packets is based on the initial storage capacity.

16. The method of claim 11, wherein the additional data includes a plurality of copies of the first data packet being retransmitted, robust coding of the first data packet being retransmitted, or additional data packets, a type of the additional data being based on the remaining storage capacity and a transmission condition of a channel in the communication system.

17. The method of claim 11, wherein the plurality of data packets are transmitted over HARQ channels identified by HARQ channel identifiers, and a connection identifier using a plurality of HARQ channels to transmit the data packets, the connection identifiers identifying transmission capacities of the HARQ channels, the transmission and the retransmission being controlled based on the transmission capacities and the remaining storage capacity of the first buffer.

18. The method of claim 11, further comprising detecting the error in the first data packet by decoding error detection bits included in the first data packet.

19. The method of claim 11, wherein the plurality of data packets are received in a sequence indicating an order for processing the plurality of data packets, the first data packet being any data packet in the sequence.

20. The method of claim 11, wherein the plurality of data packets are transmitted over N HARQ channels such that the initial storage capacity of the first buffer is used to determine a number of the HARQ channels that are used per connection for the transmission.

21. An apparatus for optimizing communication, comprising:
a first buffer having an initial storage capacity;
a receiver to receive a plurality of data packets including a first data packet, wherein at least one of the plurality of data packets is stored in the first buffer when the first data packet includes an error;
a processor to determine a remaining storage capacity of the first buffer based on the initial storage capacity and a storage capacity used to store the at least one of the plurality of data packets; and
a transmitter to request retransmission of the first data packet,
wherein the receiver receives retransmission of the first data packet with additional data, an amount of the additional data included in the retransmission based on the remaining storage capacity of the first buffer.

22. The apparatus of claim 21, wherein the additional data includes a plurality of copies of the first data packet being retransmitted, robust coding of the first data packet being retransmitted, or additional data packets, a type of the additional data being based on the remaining storage capacity and a transmission condition of a channel in the communication system.

23. The apparatus of claim 21, wherein the apparatus is a mobile station in communication with a base station in a communication system and the plurality of data packets are received over N HARQ channels of the communication system.

24. An apparatus for optimizing communication, comprising:
a transmitter to transmit a plurality of data packets including a first data packet, wherein at least one of the plurality of data packets is stored in a first buffer when the first data packet includes an error; and
a receiver to receive a request of retransmission of the first data packet,
wherein the transmitter retransmits the first data packet with additional data, an amount of the additional data included in the retransmission based on a remaining storage capacity of the first buffer determined based on an initial storage capacity of the first buffer and a storage capacity used to store the at least one of the plurality of data packets.

25. The apparatus of claim 24, wherein the additional data includes a plurality of copies of the first data packet being retransmitted, robust coding of the first data packet being retransmitted, or additional data packets, a type of the additional data being based on the remaining storage capacity and a transmission condition of a channel in the communication system.

26. The apparatus of claim 24, wherein the apparatus is a base station in communication with a mobile station in a communication system and the plurality of data packets are transmitted over N HARQ channels of the communication system.

27. A communication system optimizing communication between a first node and a second node, comprising:
a first buffer having an initial storage capacity, the first buffer included in the second node;
a first node transmitter to transmit a plurality of data packets, including a first data packet, to the second node, wherein at least one of the plurality of data packets is stored in the first buffer when the first data packet includes an error; and
a second node transmitter requesting retransmission of the first data packet such that the first node transmitter retransmits the first data packet with additional data to the second node,
wherein an amount of the additional data is included in the retransmission based on a remaining storage capacity of the first buffer that is determined based on the initial storage capacity and a storage capacity used to store the at least one of the plurality of data packets.

28. The apparatus of claim 27, wherein the additional data includes a plurality of copies of the first data packet being retransmitted, robust coding of the first data packet being retransmitted, or additional data packets, a type of the additional data being based on the remaining storage capacity and a transmission condition of a channel in the communication system.

29. The communication system of claim 27, wherein the first node is a base station and the second node is a mobile station in the communication system and the plurality of data packets are transmitted over N HARQ channels of the communication system.
